(19) United States
(12) Patent Application Publication
(10) Pub. No.: US 2012/0252497 A1
(43) Pub. Date: Oct. 4, 2012

(54) LOCATION-BASED MOBILE APPLICATION

(76) Inventor: Aaron Altscher, Baltimore, MD (US)

(21) Appl. No.: 13/433,267

(22) Filed: Mar. 28, 2012

Related U.S. Application Data
(60) Provisional application No. 61/468,321, filed on Mar. 28, 2011.

(51) Int. Cl. H04W 64/00

(52) U.S. Cl. 455/456.3; 455/456.1

(57) ABSTRACT

A location-based question and answer mobile application method and system is disclosed. The system has a processor coupled to a nontransitory computer readable medium, the computer readable medium containing software instructions that, when executed by the processor, cause the processor to perform a series of operations. The operations can include presenting a user interface for receiving a question, the user interface adapted to be displayed on a user device, and receiving a question via the user interface. The operations can also include obtaining a location associated with the question, and publishing the question to other users associated with the location of the question.

### RELATED APPLICATIONS

This application claims the benefit of U.S. Provisional Application No. 61/468,321, filed on Mar. 28, 2011, entitled “Location-based Mobile Question and Answer System, Method, and Computer Readable Media,” which is incorporated herein by reference in its entirety.

### FIELD

Embodiments relate generally to computerized mobile device applications and, more particularly, to systems, methods and computer readable media for location-based mobile applications.

### BACKGROUND

Mobile devices typically include one or more location determination modules (e.g., global positioning system receivers, cellular network location determination, and the like). Because a user of a mobile device is typically not stationary, it may be desirable to provide information to the user based on the user's past, present or future location.

### SUMMARY

An embodiment includes a location-based question and answer mobile application system. The system has a processor coupled to a nontransitory computer readable medium, the computer readable medium having stored therein software instructions that, when executed by the processor, cause the processor to perform a series of operations. The operations can include presenting a user interface for receiving a question, the user interface adapted to be displayed on a user device, and receiving a question via the user interface. The operations can also include obtaining a location associated with the question, and publishing the question to other users associated with the location of the question.

At least one embodiment can include a location-based mobile application system having a processor coupled to a nontransitory computer readable medium, the computer readable medium having stored therein software instructions that, when executed by the processor, cause the processor to perform a series of operations. The operations can include receiving permission to obtain a location of a user device and obtaining a location of the user device, when permission is received to obtain the location. The operations can also include transmitting the location of the user device to a server, and receiving an indication of respective locations of other user devices in an area close to the user device, the other user devices having transmitted respective locations to the server based on respective permissions received at each of the other user devices.

Yet another embodiment can include a location-based event mobile application system having a processor coupled to a nontransitory computer readable medium, the computer readable medium having stored therein software instructions that, when executed by the processor, cause the processor to perform a series of operations. The operations can include presenting a user interface for receiving a question, the user interface adapted to be displayed on a user device, and receiving a question via the user interface.

The operations can also include obtaining a location associated with the question, the location corresponding to a location associated with the event, and publishing the question to other users associated with the event.

### BRIEF DESCRIPTION OF THE DRAWINGS

FIG. 1 shows an example graphical user interface for a location-based mobile application question and answer system in accordance with at least one embodiment.

FIG. 2 shows an example graphical user interface for entering a question to submit to a location-based mobile application question and answer system in accordance with at least one embodiment.

FIG. 3 shows an example graphical user interface for a location-based mobile application question and answer system in accordance with at least one embodiment.

FIG. 4 shows an example graphical user interface for displaying nearby locations in a location-based mobile application question and answer system in accordance with at least one embodiment.

FIG. 5 shows an example graphical user interface for connecting a user of a location-based mobile application question and answer system to a social media service (e.g., Facebook, LinkedIn, or the like) in accordance with at least one embodiment.

FIG. 6 is a diagram of an example location-based mobile application question and answer system in accordance with at least one embodiment.

FIG. 7 is a chart showing an example method for a location-based mobile application question and answer system in accordance with at least one embodiment.

FIG. 8 is a chart showing an example method for asking a question using a location-based mobile application question and answer system in accordance with at least one embodiment.

FIG. 9 is a chart showing an example method for answering a question using a location-based mobile application question and answer system in accordance with at least one embodiment.

FIG. 10 shows an example graphical user interface for choosing a location and asking a question using a location-based mobile application question and answer system in accordance with at least one embodiment.

FIG. 11 shows an example graphical user interface for displaying a list or map of questions in a location-based mobile application question and answer system in accordance with at least one embodiment.

FIG. 12 shows an example graphical user interface for displaying a list of nearby questions in a location-based mobile application question and answer system in accordance with at least one embodiment.

FIG. 13 shows an example graphical user interface for displaying nearby offers in a location-based mobile application question and answer system in accordance with at least one embodiment.

FIG. 14 shows an example graphical user interface for displaying a feed of recent user activity in a location-based mobile application question and answer system in accordance with at least one embodiment.

FIG. 15 shows an example graphical user interface for displaying an initial screen showing an advertisement in a location-based mobile application question and answer system in accordance with at least one embodiment.

FIG. 16 shows an example graphical user interface for displaying a list of answers in a location-based mobile application question and answer system in accordance with at least one embodiment.

### DETAILED DESCRIPTION

While embodiments shown in the figures, and described below, relate to asking/answering questions in a location-based mobile application with a focus on a location associated with the question, it will be appreciated that the location-based question/answer system, method and computer readable media disclosed herein can be applied to numerous areas of information searching and ecommerce, such as academic research, consumer or business purchasing, real estate listing searches, web site searches, classified ads selling anything, auction listings, vacation rentals or the like. In general, an embodiment can be used for any type of information system in which searching and/or transacting using location information may be desirable.

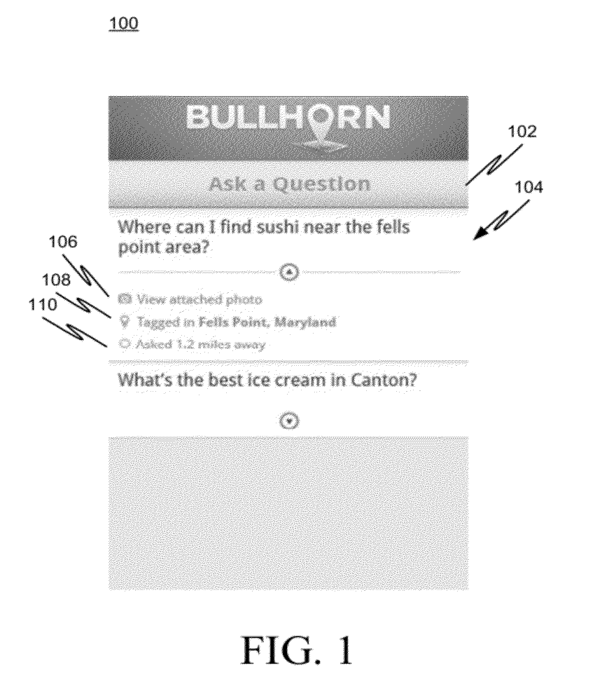

FIG. 1 shows an example graphical user interface (GUI) screen 100 for a location-based mobile application question and answer system. In particular, the GUI shown in FIG. 1 includes a button for asking a question 102, a list of nearby questions 104, and options for viewing any attached photo or video 106, viewing a tagged location 108 and viewing the distance from the user that the question was asked 110.

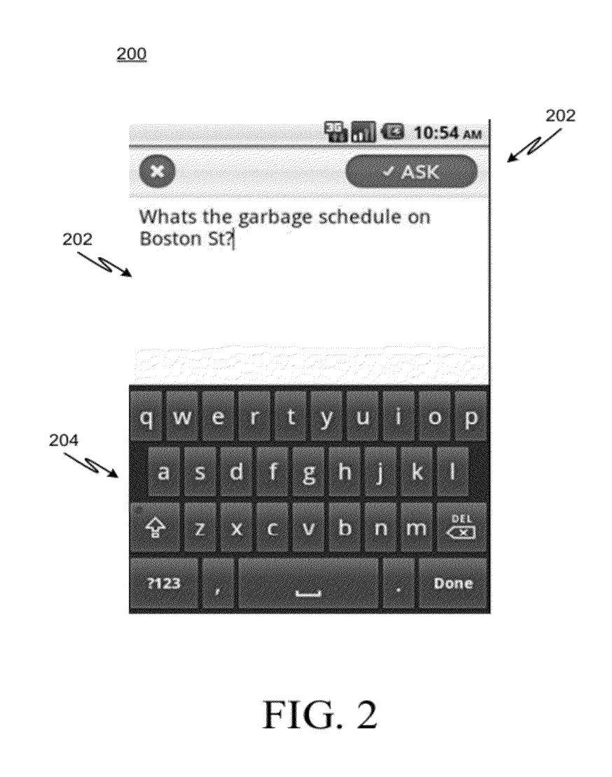

FIG. 2 shows an example GUI for entering a question 200 for submission to a location-based mobile application question and answer system. In particular, the GUI of FIG. 2 shows a space for entering text 202, a touch-screen based keyboard 204 and an “Ask” button 206. The touch-screen based keyboard 204 can be provided by the mobile device operating system, or can be provided by the mobile location-based application.

In operation, a user would enter a question via the touch-screen keyboard 204 (or via other input method such as voice, physical keyboard, or the like) and then press the Ask button 206 to submit the question to the location-based question and answer server. The user's location can be obtained by the application running on the user's device (e.g., via a GPS module within a wireless device, via cellular location system, or the like) or by another method such as direct keyboard entry of location, selection of a tagged location or selection of a location from a map displayed on the user's device.

The submitted question can be presented to other users nearby or other users who may not be nearby, but which have indicated knowledge of the location associated with the submitted question. For example, a user may have grown up in a first city and recently moved to a second city. The user can select to receive questions about the first city even though he/she is located or residing in a different city.

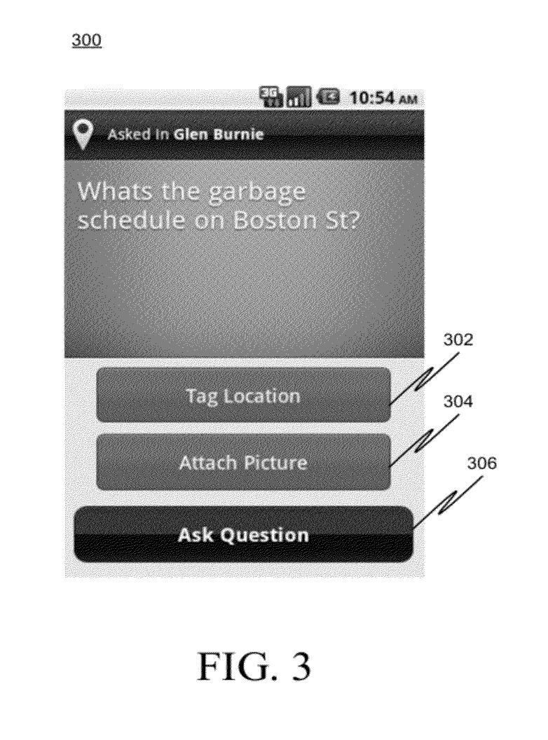

FIG. 3 shows an example GUI 300 for a location-based mobile application question and answer system.

After the user types in their question (e.g., using the GUI shown in FIG. 2) and hits the “ask” button, the system can cause a screen similar to that shown in FIG. 3 to be displayed. The user can be provided with GUI elements for tagging the location of the question 302, attaching a photo to the question 304, and publishing the question 306.

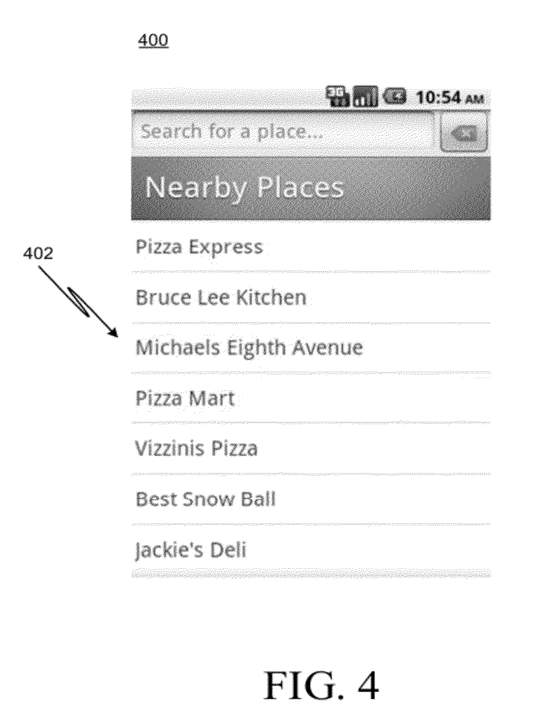

FIG. 4 shows an example GUI 400 for displaying nearby locations in a location-based mobile application question and answer system.

If the user selects “Tag Location” (e.g., using the screen shown in FIG. 3) the system can read the location of the user (e.g., via GPS coordinates from mobile device, triangulation by wireless carrier, or entered location) and pull a list of local places 402 around the user's location. The user can double click on a map (e.g., Google map) to drop a tack icon at a location of the question, assigning it a longitude and latitude in the mobile application question and answer system database.

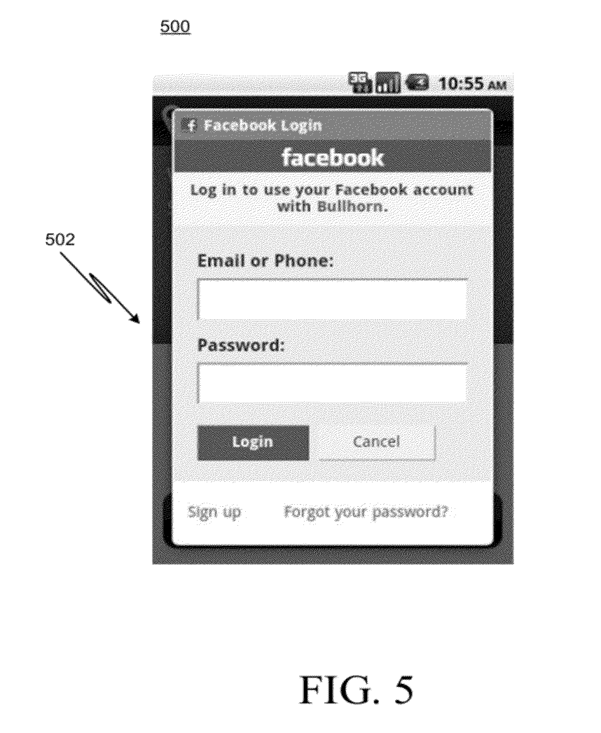

FIG. 5 shows an example GUI 500 for connecting a user of a location-based question and answer service to a social media service (e.g., Facebook.com) in accordance with the present disclosure.

After the user selects “Ask Question” the system can display a login interface for a social media service 502 (e.g., Facebook using Facebook connect, or other social media service). Once the user logs in, the mobile application system can store their userID and associate all activity (e.g., questions and answers) to this userID. The system can then publish question and answer service activity to the user's social network page (e.g., the user's Facebook “wall”).

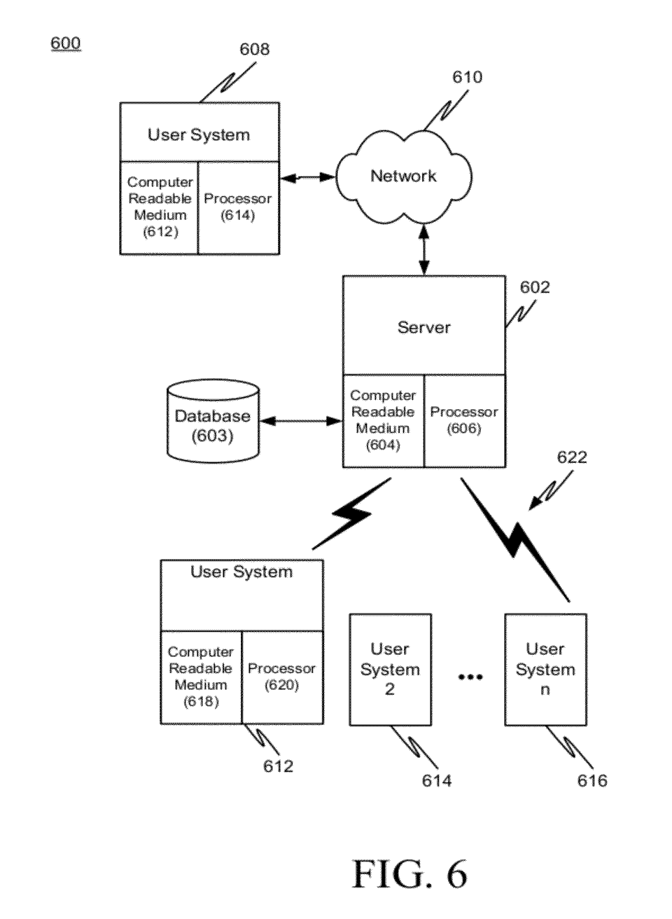

FIG. 6 is a diagram of an exemplary system for a location-based question/answer service. In particular, FIG. 6 shows a system 600 having a server computer 602 (with a nontransitory computer readable medium 604 and a processor 606), a database 603, a user system 608 (with a nontransitory computer readable medium 612 and a processor 614) and a network 610 coupling the server computer 602 and the user system 608. The system 600 can also optionally include other user systems 612-616. Each user system 612-616 having a nontransitory computer readable medium and processor (as shown in 612 as 618 and 620 respectively, but not shown in the others for simplicity). The other user systems 612-616 can communicate with the server via link 622.

The server computer 602 can include a single server computer, a distributed server computer, a cloud computing system or any computing system suitable for performing server functions. In general, any computing device capable of being programmed to perform location-based question and answer server functions in accordance with the present disclosure can be used.

The user systems (608 and 612-616) can be a wireless phone (e.g., an Android-based wireless device, an Apple iPhone, a feature phone, a smart phone or the like), a personal digital assistant (e.g., a Blackberry, a Palm OS device, a Windows Mobile device or the like), a portable computer (e.g., a laptop, netbook, notepad computer, tablet computer, Apple iPad, palm top computer or the like), an ebook reader (e.g., Amazon Kindle, Barnes and Noble Nook, Sony ebook reader or the like), a portable media player (e.g., Apple iTouch or the like), a desktop computer (e.g., a PC-compatible, an Apple Macintosh, Unix-based system or the like) or other suitable computing device. In general, any computing device capable of being programmed to perform functions in accordance with an embodiment can be used.

Each nontransitory computer readable medium mentioned above (604, 612 and 618) can include RAM, ROM, EEPROM, flash memory, CD, DVD, magnetic disc drive, optical disc drive, electronic memory and/or any now known or later developed computer readable medium suitable for storing instructions and/or data.

Each processor (606, 614 and 620) can include a microprocessor, microcontroller, digital signal processor, application specific integrated circuit, programmable logic device and/or the like.

The network 610 and link 622 can each include one or more of a local area network, a wide area network, the Internet, a virtual private network, a wireless network (WiFi, cellular, Bluetooth or the like), a wired network or the like.

In operation, a user (e.g., an individual searching for an answer to a location-specific question) can use the user system 608 to access the mobile application server 602. The software for the accessing the server can be executed from the user system 608 nontransitory computer readable medium 612. The software can include, for example, an application (or “app”) that is downloaded from an online application marketplace such as that provided for the iPhone, Android, Blackberry and Palm wireless devices. Alternatively, or in addition to an application, the software can be provided from the server computer 602 in the form of software as a service or as a web service. The user can use the user system 608 to ask or answer questions. The GUI for questions and answers can be displayed on a display device coupled to, or integrated with, the user systems.

The server computer 602 can be programmed to provide listings of questions and answers to user devices based on the location of the user devices. The server computer 602 can retrieve user information, questions and answers from the database 603. The location can be the actual location of the user device (e.g., as obtained from a location system such as GPS within a user device, triangulated by wireless carrier, obtained from an IP address (or the like), or entered or selected from a map by the user) or another location. For example, a user may wish to answer questions for a location they are familiar with (e.g., their hometown) while they are not present in that location (e.g., away on travel). Further, a user may wish to view questions and answers for a location that the user is contemplating a trip to (e.g., a location for business or pleasure travel).

While the system of FIG. 6 has been described in connection with a location-based mobile application question and answer system, it can also be used for any of the mobile application system embodiments described herein, e.g., enterprise application system, organization application system, real estate application system and/or event application system.

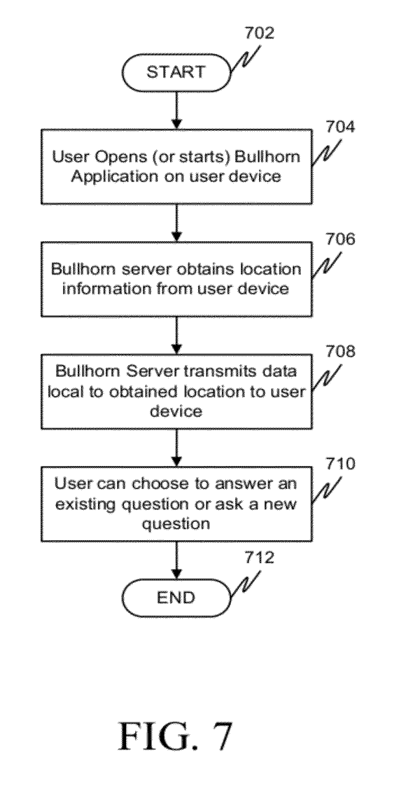

FIG. 7 is a chart showing an exemplary method for a location-based question and answer service in accordance with at least one embodiment. Processing begins at 702 and continues to 704.

At 704, a user opens (or starts) the question and answer service application on the user device (e.g., opens the app on the user's mobile device). Processing continues to 706.

At 706, the mobile device application obtains location information from the user device and forwards it to the question and answer server. For example, if the user device is a mobile phone or other wireless device, the server can obtain the location information (e.g., latitude and longitude information) forwarded from the device using either GPS or signal triangulation from the cell provider. The location data can be in JSON encoded data format, for example, which includes additional information such as altitude and speed. Processing continues to 708.

At 708, the system (e.g., via the mobile device application, the mobile application server, or both) presents the user with one or more graphical user interface screens (or screen choices) to permit the user to ask a question or answer a question (described in greater detail below). Processing continues to 710, where processing ends.

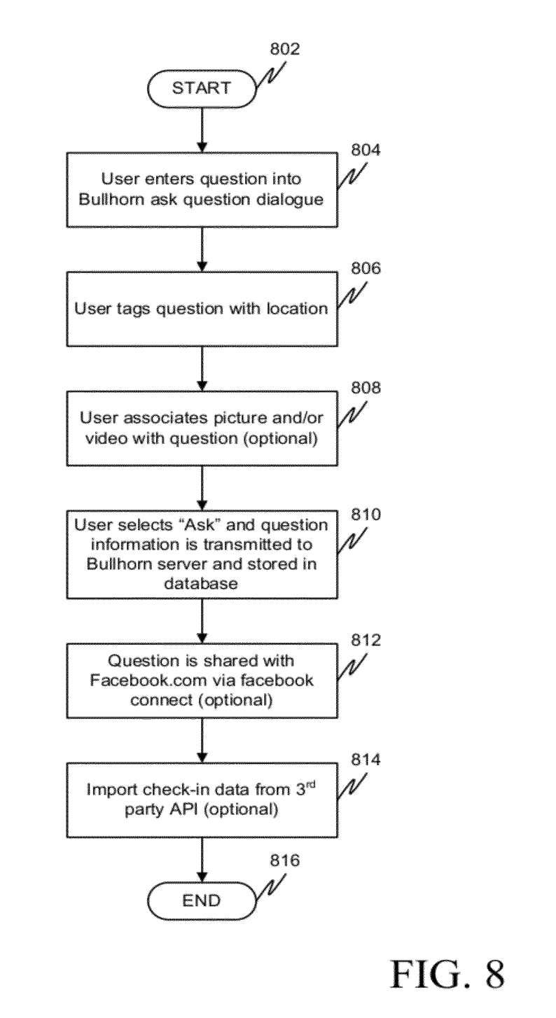

FIG. 8 is a chart showing an exemplary method for asking a question using a location-based mobile application question and answer system. Processing begins at 802 and continues to 804.

At 804, the system provides an “ask a question” dialog box (e.g., similar to that shown in FIG. 2) and receives input from a user. Processing continues to 806.

At 806, the system provides a GUI to permit the user to tag a question with a location (e.g., using screens similar to FIGS. 3 and 4) and can receive the location tag information. The location can be selected from a list of location tags near to the user's location or can be created by the user (and added to the list of location tags). Processing continues to 808.

At 808, the system provides a GUI to permit the user to optionally associate a media content item (e.g., a picture, a video, audio clip or the like) with the question. The question and answer server can receive the media element from the user device via standard transfer protocols. For example, when a user asks a question they have the option to upload a picture along with the question which will appear on the Answer Question page as a thumbnail. In another example, if the user is standing in front of the Babe Ruth statue at Oriole Park and wanted to ask the question “Did Babe Ruth ever live in Baltimore?” The user could attach a photo of the statue along with my question so that prospective answerers could see the answer text, location, and photo of the Babe Ruth statue. Processing continues to 810.

At 810, the system causes an “ask” button to appear in a user interface dialog (e.g., similar to that shown in FIG. 3), and the system can receive an ask button indication when the user presses the button on the device screen. The question and any associated user location information can be automatically transferred from the mobile application on the user device to the question and answer server and can be subsequently published to other users of the location-based question and answer system. Processing continues to 812.

At 812, the system optionally publishes the user's question to a social media service (e.g., Facebook or the like). The user's questions (and answers) can be published to the social media service if the user has logged into the social media service (e.g., Facebook) using an interface screen (e.g., similar to that shown in FIG. 5). For example, the social media connection feature can permit the location-based question and answer server to store the user's activity with a Facebook profile to display activity data in the user's profile (My Profile) as well as allow the user to publish the question to their Facebook wall so their friends can answer. Processing continues to 814.

At 814, the location-based question and answer system can optionally access a check-in service (either a standalone service or a check-in service associated with a social media service). For example, by accessing a social media service (e.g., the Facebook connect platform) the location-based question and answer server will have access to Facebook user activity. Specifically, the server can access a check in service (e.g., Facebook Places—Facebook's check-in service). For example, if a user asks a question and is located at the Columbia Mall while logged into Facebook connect, the Facebook API will be able to inform the question and answer server as to which Facebook friends of the user have checked-in using Facebook places to stores in the Columbia Mall. If the question and answer server can determine which friends of the user have checked into this location most frequently, the server can prompt those friends to answer the question and potentially get a more accurate answer. Processing continues to 816, where processing ends.

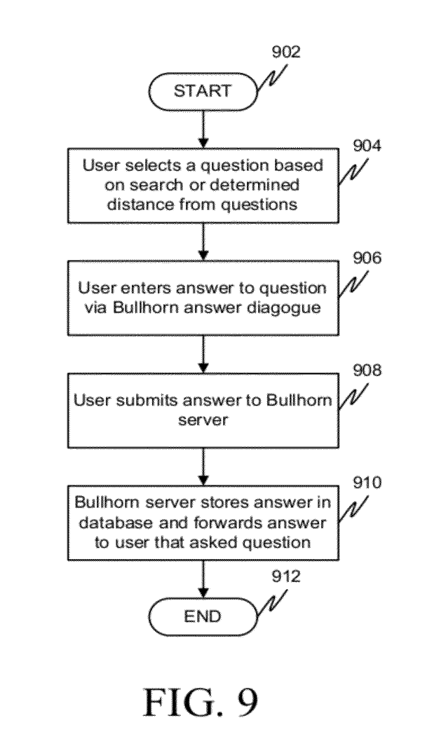

FIG. 9 is a chart showing an example method for answering a question using a location-based question and answer service in accordance with at least one embodiment. Processing begins at 902 and continues 904.

At 904, the system present a user with questions based on search results or location-information and receives a selection from the user. For example, a user familiar with a certain area may search on that area to see what questions have been asked relating to that area. Also, the location-based question and answer server can determine the user's location and provide a list of questions associated with an area surrounding the user's location. Also, the location-based question and answer server, if permitted, can access check-in information from a third-party service (e.g., Facebook Places) associated with the user and then provide questions to the user based on check-in information. Processing continues to 906.

At 906, the system present the user with an answer GUI and obtains an answer to the selected question from the user via an answer dialog (or interface screen) presented to the user. Processing continues to 908.

At 908, the system receives an indication that the user has submitted the answer to the location-based question and answer server. Processing continues to 910.

At 910, the location-based question and answer system stores the answer and forwards the answer (or a link to the answer) to the user that asked the question (and also can provide the answer to other users, for example other users in a nearby location). Processing continues to 912, where processing ends.

Any of the steps described above in any of the method (or process) charts can be repeated in whole or in part to accomplish a respective task or operation.

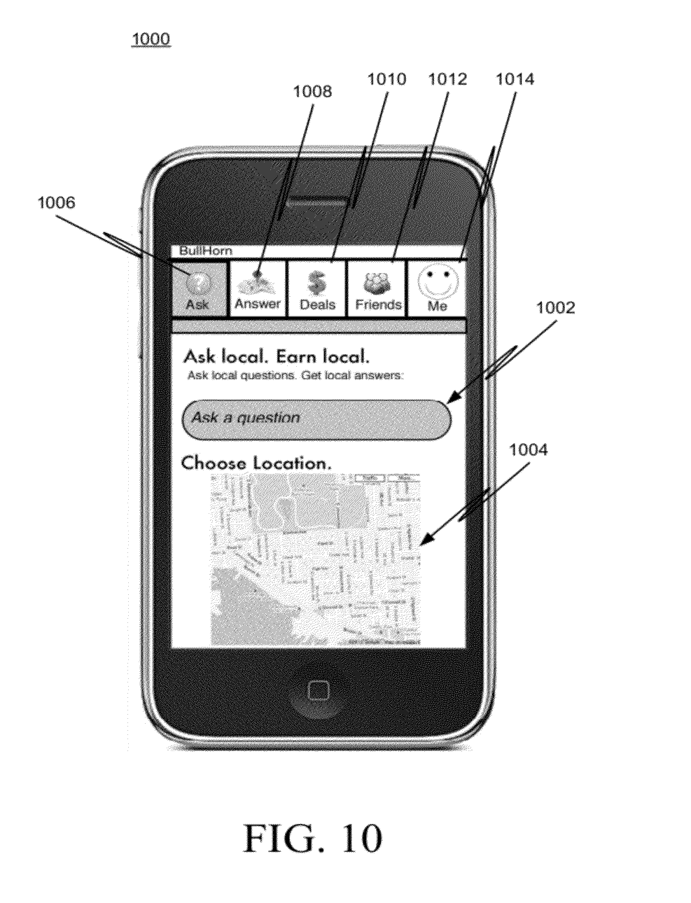

FIG. 10 shows an example GUI 1000 for choosing a location and asking a question using a location-based question and answer service. The GUI 1000 includes a button for asking a question 1002 and an interface element (e.g., a map) for choosing a location 1004. The GUI 1000 also includes a menu having selections for asking a question 1006, answering a question 1008, viewing deals 1010, viewing friends 1012 and viewing the user's own profile and/or activity information 1014.

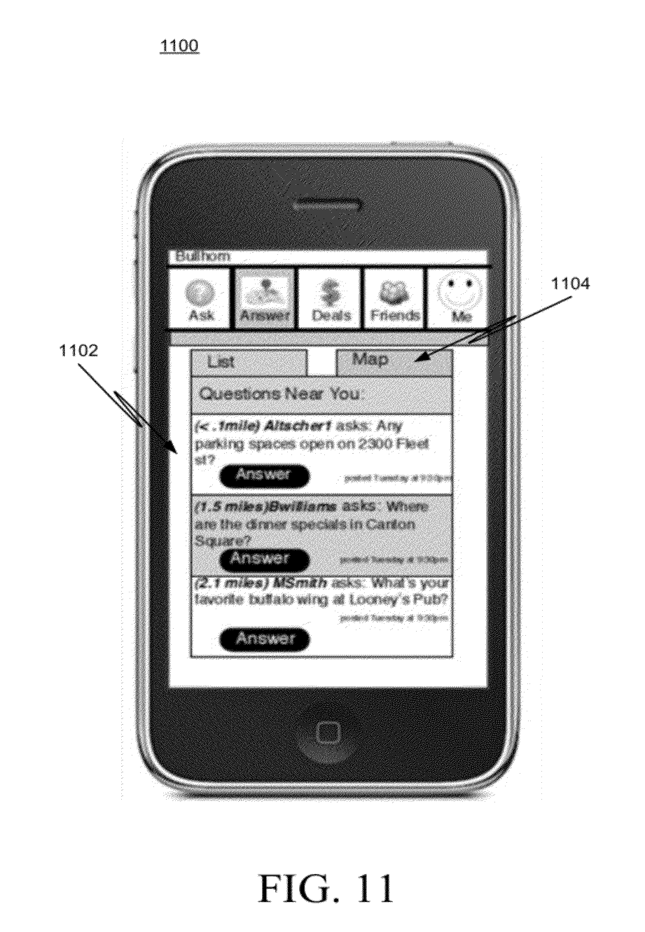

FIG. 11 shows an example GUI 1100 for displaying a list 1102 or map 1104 of questions in a location-based question and answer system. The list or map items are retrieved from the mobile application server based on a request from a mobile application executing on a user device.

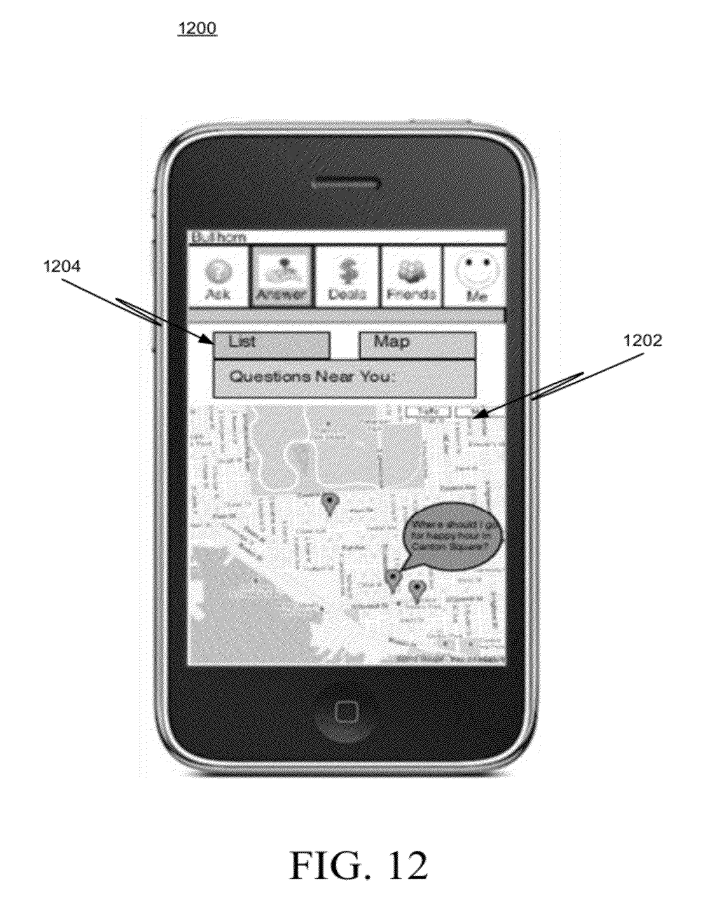

FIG. 12 shows an example GUI 1200 for displaying a list of nearby questions in a location-based question and answer system in map form 1202 or list form 1204.

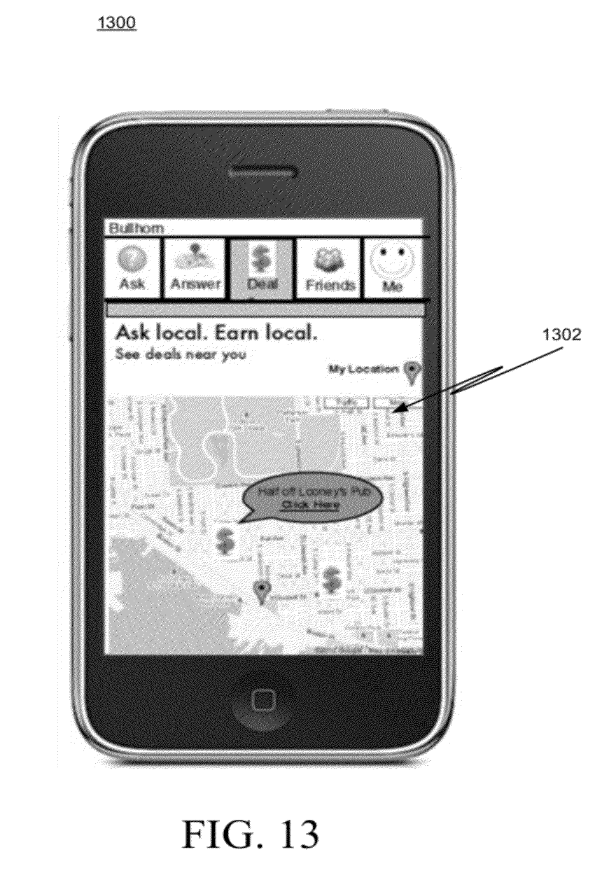

FIG. 13 shows an example GUI 1300 for displaying nearby offers 1302 in a location-based question and answer system.

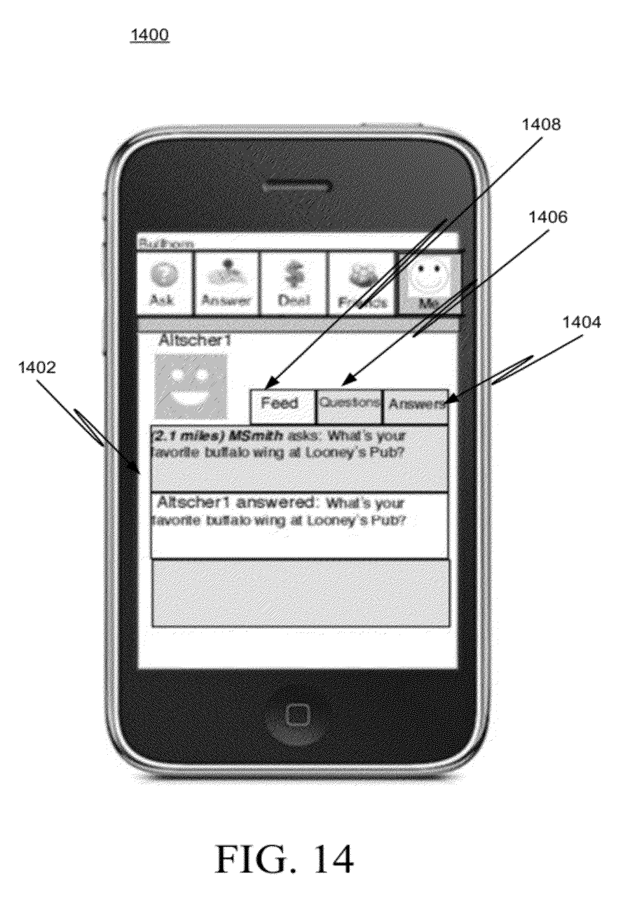

FIG. 14 shows an example GUI 1400 for displaying a feed 1402 of recent user activity in a location-based question and answer service in accordance with the present disclosure. In particular, FIG. 14 shows a profile page within the location-based question and answer mobile application. If a user asks a question then closes the app, the screen shown in FIG. 14 provides a centralized location (e.g., a profile page) for displaying the user's activity. The profile page can include questions asked 1406, questions answered 1404, media (e.g., pictures, video, audio or the like) uploaded by the user, a feed 1408, or the like.

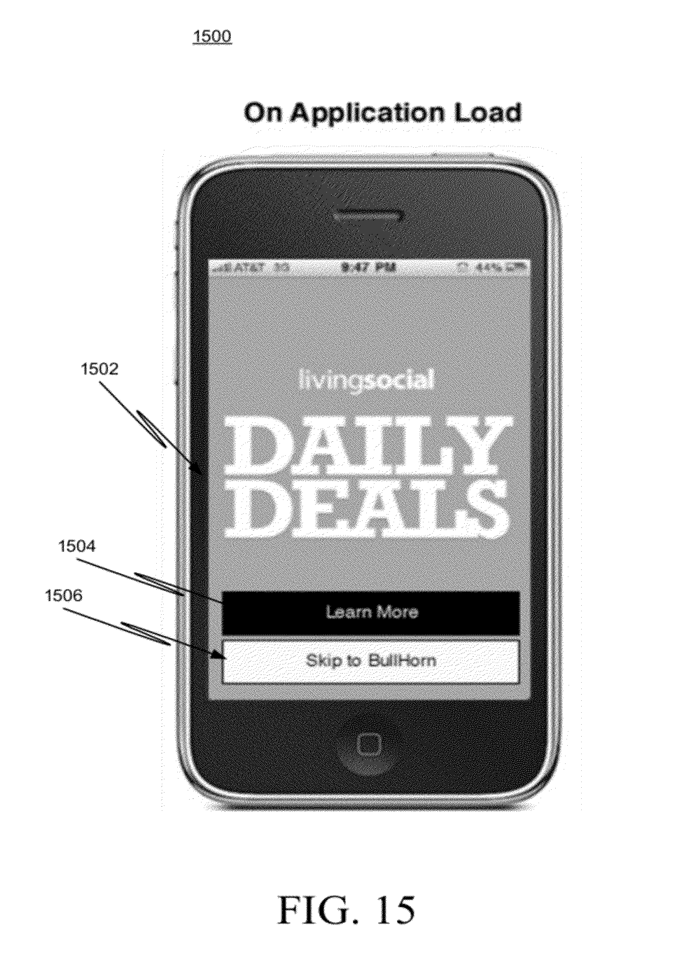

FIG. 15 shows an example GUI 1500 for displaying an initial screen showing an advertisement in a location-based question and answer system. A user can choose to learn more 1502 about the advertisement or offer, or continue to the mobile application 1504. The advertisement can be selected for display based on the user's location.

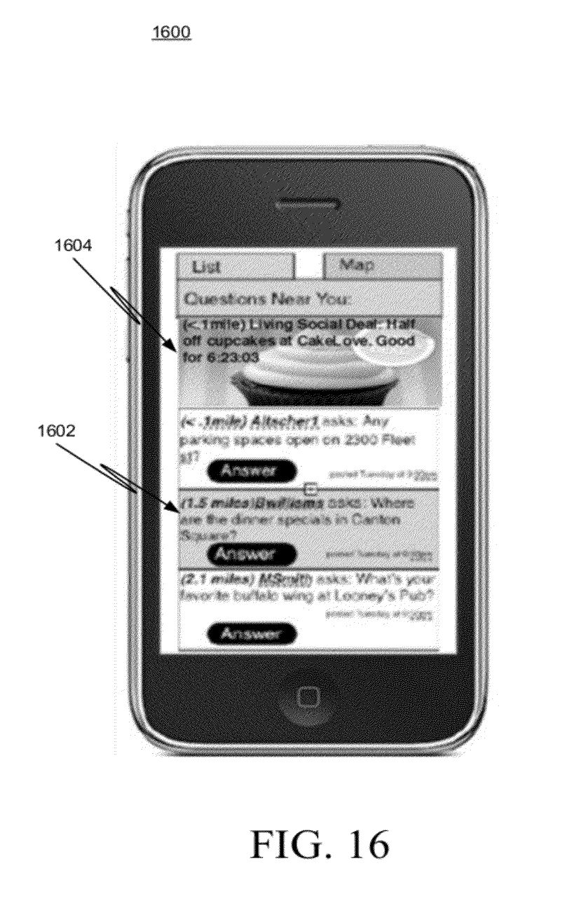

FIG. 16 shows an example GUI 1600 for displaying a list of answers 1602 in a location-based question and answer service in accordance with the present disclosure. In particular, FIG. 16 shows premium offer placements 1604 in the question list view. This is similar to a banner advertisement inside the app or a sponsored search result from a search engine.

In one embodiment, answers can be search by keyword and then sorted by location. For example, an “in app” search based on keyword feature can be provided. Search results can be sorted by location, time, and probably keyword relevancy. The app can also include a feature for saved/favorite locations and answer searches.

In one embodiment, the location-based question and answer system can attempt to match recent answers with a question. The capability for matching can be improved as the system acquires more data regarding questions and answers. For example, the server can query the question and answer database before posting question for like phrases and keyword to present the user with an answer before posting.

In one embodiment, the location-based question and answer system can also include a feedback/rating system about answers (e.g., similar to that of the Yahoo answers platform where the user accumulates credits for answering and being selected as “best answer”). The ratings could be provided on a 1-5 rating scale of answers, for example. The rating feature can also be an option for the social media interface (e.g., Facebook open graph API) where, when an answer is posted on location-based question and answer system, the system can publish back to the Facebook wall of the user where friends can vote on the answer and then voting results can be exposed to the platform.

Also, in an embodiment, the question and answer system can also take into account other factors such as day of the week, date, or time-of-day into the question and answer process. For example, recognizing that an answer posted last Saturday night for a given location may be relevant again on a following Saturday night. There may be relevance and a correlation between the day/date/time of day and the type of questions that are asked. Accordingly, the system can take this type of additional information into account when associating questions, answers and/or locations.

Also, in addition to a general purpose, public version of the location-based questions and answer service, a private label version may be provided. For example, an embodiment could be configured as a “Preakness Bullhorn” open to only users at the Preakness horse race. In the private label embodiment, the service could be provided on a sponsorship basis in which an event manager could sell advertising on their private labeled location-based question and answer network. An event manager could selectively permit (or moderate) questions and answers being published. In other words a third-party user can select to permit a question or answer of another user to be published.

Also, in an embodiment, the location-based question and answer service could be provided as a private question/answer portal in which event staff (or staff of an organization or business) provide answers to patron's questions.

An embodiment can include a community question and answer system. The community question and answer system can provide an interface for displaying questions sorted by one or more of time, distance, popular activity or the like. Further, the system can include a voting system for obtaining votes on questions and/or answers. Points can be given for users who receive positive votes for questions or answers provided. The points can be used for merchant deals, discounts, coupons, and titles (e.g., Location Relevant Expert).

The system can also include an interface to integrate with and exchange data with a social media network such as Facebook, Twitter, Tumblr and the like.

The system can notify users of platform activity such as new questions, new answers, new votes and users nearby. The notification is selectable according to one or more parameters such as on/off, frequency (e.g., immediately, hourly, daily, weekly, or the like), group of users whose actions trigger notifications, or the like.

The system can cause a map to be displayed showing users, places, events and/or questions selectively plotted on the map. Location information (e.g., GPS coordinates) can be provided with each question so that a user can open a navigation/map system by selecting the location information and view the location on a map or obtain directions to the location. Questions and/or answers can include hyper text links that a user can select (or click on) to open the link in a browser. Questions and/or answers can be associated with an event.

Users can select tags for a question or answer. A tag can be selected from a list of existing tags or may be created by a user. Questions can be searched by one or more of content, tags, users, locations, event and place.

Another embodiment can include a location-based organization mobile application system. For example, the system can be used to connect alumni of a school. Alumni can load the mobile application software portion of the system on their respective mobile devices. The system can collect information about the location of alumni and other characteristics such as major, class year, organizations, and the like.

The system can then display to each user an indication of other alumni in their area. The display can be filtered by information associated with each user such as major, class year, organizations and the like. Users can send a message to each other, request a meet up and ask a question of each other via a user interface displayed by the mobile application. All of the functions can be performed in conjunction with the location-based framework of the question and answer system described above.

Users can also enter certain information such as name, major, class year, current organization and title, location and group affiliations, which can be displayed to other users via the mobile application user interface.

In another embodiment, the location-based mobile application system can be adapted for use at an event such as a conference, festival or race. In an event embodiment, the system can track event participants (e.g., racers) using location information sent from each participating racer's device to other users via a server. The other users having provided an indication of a desire to track one or more racers. Thus, spectators at a race event can track the position of one or more racers in real time on a user interface display that includes a map of the race course with the locations of each tracked racer being displayed on the map using a symbol that moves in response to the received location information for that racer.

In addition to tracking location of event participants, the system can provide an event map and schedule, in which schedule items can be linked to locations on the map. Also, the system can provide a list of vendors and/or sponsors, with an option for a location to be displayed on the map.

The system can provide a question and answer section in accordance with the location-based question and answer system described above. The question and answer section can optionally be supported and/or moderated by an event organizer or official. The system can provide push and SMS notifications based on user selected preferences. Alerts or notification can be scheduled and automated. The system can also provide an interface to a camera in a user device and permit pictures taken with the user device to be uploaded to the system server for publication to other users of the event system (or to anyone).

The event system can include an interface to social media networks (e.g., Facebook, Twitter and the like). Maps displayed by the system can include maps served by an external system (e.g., Google maps), which provide maps and directions to points of interest within the event (e.g., start/finish, pavilion or the like). The system can provide a mobile application based event registration process and gear/equipment ordering function via the mobile application. The system can include “back end” administration functions such as a web portal to access and administer system features, data and settings. The functions can include one or more of sending an alert, flagging and/or removing a question or answer, adding/editing/deleting users, managing user information/accounts, and the like.

Another embodiment includes a mobile application system for commercial and/or residential real estate (e.g., apartments, condominiums, recreational vehicle parks, camp grounds, timeshare developments, hotels, motels, townhouse neighborhoods, single family homes, and neighborhoods/communities having a mixture of the above). The mobile application can include functions that permit users to pay for things associated with property, such as, for example, rent and/or homeowners association fees. The mobile application can user the location-based features described above to allow nearby neighbors to connect with each other (e.g., messaging, question and answer, and the like). The mobile application system can permit users to plan and organize community events.

The mobile application system can provide a marketplace for buying and selling goods within the mobile application users associated with the property.

Using a method similar to the location-based question/answer method described above, the real estate mobile application can permit users to submit service and/or maintenance requests in a manner similar to that described above for questions and to receive a response to a maintenance request in a manner similar to the answer process described above. In the real estate embodiment, the response can include an update on the status of a service request, a scheduled day and/or time that maintenance personnel will respond to the request, or the like. In general, responses to maintenance or service requests can be provided by a predetermined group such as property management personnel and/or maintenance personnel. Each maintenance person and/or member of management could be assigned to respond to service requests arriving from respective areas (or locations) of a property.

The mobile property management system can also include functions for managing service requests (e.g., notifying users that a service request has been marked as pending, closed, or the like), managing an events calendar, managing the marketplace, managing users and sending alerts to residents via SMS, push, email or a combination of one or more of the above. Managing of the different items mentioned above can include adding, editing and deleting.

The mobile application can also include an interface for communicating with property security to alert security of potential problems, request/notify for visitor access, or the like. The mobile application can also provide users with a list of nearby service providers approved or familiar to property management. For example, the mobile application can provide a list of food delivery services nearby along with ratings and/or reviews entered by other residents. The listing can include links to access the service provider website and/or phone.

The mobile application can also provide a map and/or listing of points/places of interest near the subject property, the points/places being plotted on the map or listed in the list. In general, any of the information described above can be received from a user mobile device via a server and stored in a database to be provided to the mobile devices of other users according to the operations of the mobile application and/or server system.

It will be appreciated that the modules, processes, systems, and sections described above can be implemented in hardware, hardware programmed by software, software instructions stored on a nontransitory computer readable medium or a combination of the above. A system for location-based questions and answers, for example, can include using a processor configured to execute a sequence of programmed instructions stored on a nontransitory computer readable medium (e.g., a mobile device processor and/or a server system processor). For example, the processor can include, but not be limited to, a personal computer, workstation, server or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the functional description provided herein and with a general basic knowledge of the user interface and/or mobile application system computer programming arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for location-based mobile applications.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A location-based question and answer mobile application system, the system comprising:
a processor coupled to a nontransitory computer readable medium, the computer readable medium having stored therein software instructions that, when executed by the processor, cause the processor to perform a series of operations including:
presenting a user interface for receiving a question, the user interface adapted to be displayed on a user device;
receiving a question via the user interface;
obtaining a location associated with the question; and
publishing the question to other users associated with the location of the question.

2. The system of claim 1, further comprising transmitting the question and the location from the user device to a server computer.

3. The system of claim 1, wherein the operations further include:
receiving an answer to the question;
causing the answer to be displayed to the user associated with the question; and
causing the answer to be displayed to users associated with the location.

4. The system of claim 1, wherein the operations include causing questions to be displayed in the user interface, the questions being sorted according to one or more of time, distance and most popular activity.

5. The system of claim 1, further comprising providing a voting system for obtaining a vote indication associated with a question or answer.

6. The system of claim 1, wherein the system includes an interface to a social network different from the system.

7. The system of claim 4, wherein causing questions to be displayed includes displaying location coordinates.

8. A location-based mobile application system, the system comprising:
a processor coupled to a nontransitory computer readable medium, the computer readable medium having stored therein software instructions that, when executed by the processor, cause the processor to perform a series of operations including:
receiving permission to obtain a location of a user device;
obtaining a location of the user device, when permission is received to obtain the location;
transmitting the location of the user device to a server; and
receiving an indication of respective locations of other user devices in an area close to the user device, the other user devices having transmitted respective locations to the server based on respective permissions received at each of the other user devices.

9. The system of claim 8, wherein the system provides a user interface having elements for sending a message to one or more of the other user devices via the server, requesting a meet up of one or more of the other user devices via the server and asking a question of one or more of the other user devices via the server.

10. The system of claim 8, wherein the operations further include causing information associated with one or more of the other users to be displayed on the user device, the information including one or more of name, degree, class year, organization, title, location and groups within a social network.

11. A location-based event mobile application system, the system comprising:
a processor coupled to a nontransitory computer readable medium, the computer readable medium having stored therein software instructions that, when executed by the processor, cause the processor to perform a series of operations including:
presenting a user interface for receiving a question, the user interface adapted to be displayed on a user device;
receiving a question via the user interface;
obtaining a location associated with the question, the location corresponding to a location associated with the event; and
publishing the question to other users associated with the event.

12. The system of claim 11, wherein the operations further include tracking a location of a first user by receiving the location of the first user and transmitting the location of the first user to a plurality of other users, each of the other users having selected to track the location of the first user.

13. The system of claim 11, wherein the operations further include:
receiving a push notification on the user device, the push notification having information related to the event; and
causing the push notification to be displayed on the user device.

14. The system of claim 11, wherein the operations further include:
providing an interface to a camera in the user device;
receiving an image taken with the camera; and
transmitting the image to a server computer for publishing to a list of user devices associated with the event.

15. The system of claim 11, wherein the operations further include:
receiving an answer to the question;
causing the answer to be displayed to the user associated with the question; and
causing the answer to be displayed to a plurality of users associated with the event.

16. The system of claim 11, wherein the operations further include causing questions to be displayed in the user interface, the questions being sorted according to one or more of time, distance and most popular activity.

17. The system of claim 11, wherein the operations further include providing a voting system for obtaining a vote indication associated with a question or answer.

18. The system of claim 11, wherein the system includes an interface to a social network different from the system.

19. The system of claim 8, wherein the operations further include:
presenting a user interface for receiving a question, the user interface adapted to be displayed on the user device;
receiving a question via the user interface; and
publishing the question to other users.

20. The system of claim 8, wherein the operations further include:
receiving an answer to the question;
causing the answer to be displayed to the user associated with the question; and
causing the answer to be displayed to a plurality of users associated with the location.
